(19) United States
(12) Patent Application Publication
(10) Pub. No.: US 2010/0135446 A1
(43) Pub. Date: Jun. 3, 2010

(54) DIGITAL-INTENSIVE RF RECEIVER

(75) Inventors: Seon Ho Han, Daejeon (KR); Jae Hoon Shim, Daejeon (KR); Hyun Kyu Yu, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/629,684

(22) Filed: Dec. 2, 2009

(30) Foreign Application Priority Data
Dec. 3, 2008 (KR) 10-2008-0122063
Jul. 13, 2009 (KR) 10-2009-0063462

(51) Int. Cl. H04B 1/10

(52) U.S. Cl. 375/350

(57) ABSTRACT

A digital-intensive RF receiver including: a first filter unit configured to allow an RF signal of a pre-set frequency band among RF signals to pass therethrough; a low noise amplifier (LNA) configured to amplify the RF signal from the first filter unit such that the RF signal has a pre-set magnitude; a second filter unit configured to allow an RF signal of a pre-set frequency band among RF signals from the LNA to pass therethrough; a clock generation unit configured to generate a pre-set reference frequency signal and generate a sub-sampling clock having a pre-set frequency lower than an RF carrier frequency by using the reference frequency signal; a sub-sampling A/D conversion unit configured to A/D-convert the RF signal from the second filter unit into a digital signal according to the sub-sampling clock from the clock generation unit, divide the RF signal into a plurality of frequency bands and sub-sample them during the A/D conversion process and perform noise shaping by the sub-channels included in the RF signal; and a digital processing unit configured to process a digital signal from the sub-sampling A/D conversion unit according to a system clock generated by using the reference frequency signal from the clock generation unit.

### CROSS-REFERENCE TO RELATED APPLICATIONS

This application claims the priorities of Korean Patent Application Nos. 10-2008-0122063 filed on Dec. 3, 2008, and 10-2009-0063462 filed on Jul. 13, 2009 in the Korean Intellectual Property Office, the disclosures of which are incorporated herein by reference.

### BACKGROUND OF THE INVENTION

1. Field of the Invention

The present invention relates to a digital-intensive RF (Radio Frequency) receiver applicable to a communications system or a broadcast reception system and, more particularly, to a digital-intensive RF receiver capable of performing noise shaping by using the narrow bands of desired bands in converting an RF signal into an IF (Intermediate Frequency) signal or a DC-centered frequency band signal through sub-sampling A/D (Analog/Digital) conversion.

2. Description of the Related Art

In general, in developing an RF receiver that may satisfy the requirements of multiple band signals and multiple application fields, the use of a conventional analog designing method requires many circuits and components for processing analog signals, having disadvantages in the aspect of power consumption, chip area, and rapid adaptation to the market.

In comparison, as an RF receiver including digitally designed elements does not require circuits and components for processing analog signals, it can thus complement the shortcomings of the analog designing method in various aspects.

However, in actualty, it is not easy to implement such an RF receiver including many digitally designed elements in various aspects. For example, a high frequency band signal must be directly sampled, while an A/D converter should be necessarily operated at a considerably high frequency yet have a high bit resolution, making it difficult to implement the RF receiver including many digitally designed elements.

In order to process a signal with a high frequency band, the related art analog type receiver has a great deal of elements having an analog-specific design such as a mixer or the like to sufficiently lower a signal frequency, a channel filter and an automatic gain controller to reduce the burden of a bit resolution and an operation speed, and an A/D converter for processing the signal.

However, because the related art analog type receiver requires an RF tuner including the mixer or the like, it is not suitable for digital-specific design.

### SUMMARY OF THE INVENTION

An aspect of the present invention provides a digital-intensive RF receiver advantageous for digital-specific design, capable of performing noise shaping by using the narrowbands of desired bands in converting an RF signal into an IF signal or a DC-centered frequency band signal through a sub-sampling A/D conversion, thus removing the necessity of an RF tuner.

According to an aspect of the present invention, there is provided a digital-intensive RF receiver including: a first filter unit configured to allow an RF signal of a pre-set frequency band among RF signals to pass therethrough; a low noise amplifier (LNA) configured to amplify the RF signal from the first filter unit such that the RF signal has a pre-set magnitude; a second filter unit configured to allow an RF signal of a pre-set frequency band among RF signals from the LNA to pass therethrough; a clock generation unit configured to generate a pre-set reference frequency signal and generate a sub-sampling clock having a pre-set frequency lower than an RF carrier frequency by using the reference frequency signal; a sub-sampling A/D conversion unit configured to A/D-convert the RF signal from the second filter unit into a digital signal according to the sub-sampling clock from the clock generation unit, divide the RF signal into a plurality of frequency bands and sub-sample them during the A/D conversion process and perform noise shaping by using the sub-channels included in the RF signal; and a digital processing unit configured to process a digital signal from the sub-sampling A/D conversion unit according to a system clock generated by using the reference frequency signal from the clock generation unit.

The LNA may be a variable gain LNA that varies a gain according to the magnitude of the RF signal.

The clock generation unit may include: a crystal oscillator configured to generate the reference frequency signal; and a clock generator configured to generate a sub-sampling clock from the reference frequency signal generated by the crystal oscillator.

The sub-sampling clock may be one or more of a single sub-sampling clock and multiple sub-sampling clocks including a plurality of different first, second to nth sub-sampling clocks.

The sub-sampling A/D conversion unit may include: a plurality of first, second to nth sub-sampling A/D converters which divide the RF signal from the second filter unit into a plurality of frequency bands according to the single sub-sampling clock from the clock generation unit, and A/D convert each of the RF signals of the divided frequency bands into a digital signal, wherein each of the first, second to nth sub-sampling A/D converters may sub-sample the RF signals from the second filter unit according to the sub-sampling clock from the clock generation unit.

Each of the plurality of noise shaped frequencies of the plurality of the first, second to nth sub-sampling A/D converters may be set to have the same interval as that between the plurality of first, second to nth sub-channels included in the sub-sampled signals, and set to have the same frequency as a center frequency of each of the plurality of the first, second to nth sub-channels included in the sub-sampled signals.

Each of the plurality of noise shaped frequencies of the plurality of the first, second to nth sub-sampling A/D converters may be set to have the same frequency as each other, and may be set to have the same frequency as a center frequency of each of the plurality of the first, second to nth sub-channels included in the sub-sampled signals.

The digital processing unit may include: a digital frequency synthesizer configured to generate a system clock by using the reference frequency signal from the clock generation unit; and a digital signal processor configured to process a digital signal from the sub-sampling A/D conversion unit.

The sub-sampling A/D conversion unit may convert the RF signal from the second filter unit into second filter unit into one of a pre-set IF signal and DC-centered frequency band signal.

The sub-sampling A/D conversion unit may include an I-path sub-sampling A/D conversion unit and a Q-path sub-sampling A/D conversion unit, and convert the RF signals into I and Q signals which are in an orthogonal relationship by using pre-set orthogonal first and second clock signals.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of a digital-intensive RF receiver according to an exemplary embodiment of the present invention;

FIG. 2 illustrates the structure of sub-channels included in an RF signal to be processed according to an exemplary embodiment of the present invention;

FIG. 3 is a schematic block diagram illustrating a first implementation example of a sub-sampling A/D conversion unit according to an exemplary embodiment of the present invention;

FIG. 4 is graphs for explaining sub-sampling of the sub-sampling A/D conversion unit of FIG. 3;

FIG. 5 illustrates noise-shaping of the sub-sampling A/D conversion unit of FIG. 3;

FIG. 6 is a schematic block diagram illustrating a second implementation example of a sub-sampling A/D conversion unit according to an exemplary embodiment of the present invention;

FIG. 7 is graphs for explaining first sub-sampling of the sub-sampling A/D conversion unit of FIG. 6;

FIG. 8 illustrates first noise-shaping of the sub-sampling A/D conversion unit of FIG. 6;

FIG. 9 is graphs for explaining second sub-sampling of the sub-sampling A/D conversion unit of FIG. 6; and

FIG. 10 illustrates second noise-shaping of the sub-sampling A/D conversion unit of FIG. 6.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

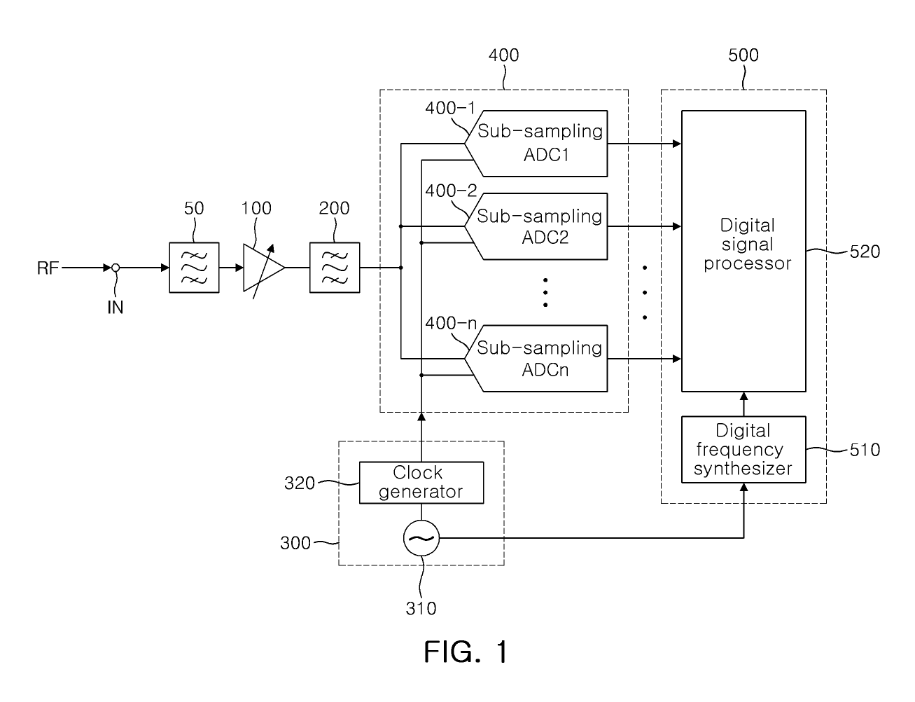

FIG. 1 is a schematic block diagram of a digital-intensive RF receiver according to an exemplary embodiment of the present invention. With reference to FIG. 1, the digital-intensive RF receiver includes a first filter unit 50 configured to allow an RF signal of a pre-set frequency band among RF signals to pass therethrough; a low noise amplifier (LNA) 100 configured to amplify the RF signal from the first filter unit 50 such that the RF signal has a pre-set magnitude; a second filter unit 200 configured to allow an RF signal of a pre-set frequency band among RF signals from the LNA 100 to pass therethrough; a clock generation unit 300 configured to generate a pre-set reference frequency signal and generate a sub-sampling clock having a pre-set frequency lower than an RF carrier frequency by using the reference frequency signal; a sub-sampling A/D conversion unit 400 configured to A/D-convert the RF signal from the second filter unit 200 into a digital signal according to the sub-sampling clock from the clock generation unit 300, divide the RF signal into a plurality of frequency bands and sub-sample them during the A/D conversion process; and perform noise shaping by the sub-channels included in the RF signal; and a digital processing unit 500 configured to process a digital signal from the sub-sampling A/D conversion unit 300 according to a system clock generated by using the reference frequency signal from the clock generation unit 300.

The LNA may be a variable gain LNA that varies a gain according to the magnitude of the RF signal.

The clock generation unit 300 includes a crystal oscillator 310 configured to generate the reference frequency signal; and a clock generator 320 configured to generate a sub-sampling clock CK from the reference frequency signal generated by the crystal oscillator 310.

The sub-sampling A/D conversion unit 400 includes a plurality of first, second to nth sub-sampling A/D converters 400-1, 400-2, . . . , 400-n which divide the RF signal from the second filter unit 200 into a plurality of frequency bands according to the single sub-sampling clock CK from the clock generation unit 300, and A/D-convert each of the RF signals of the divided frequency bands into a digital signal.

The digital processing unit 500 may include: a digital frequency synthesizer 510 configured to generate a system clock by using the reference frequency signal from the clock generation unit 300; and a digital signal processor 520 configured to process a digital signal from the sub-sampling A/D conversion unit 300. Here, the digital frequency synthesizer 510 may be a direct digital frequency synthesizer (DDFS).

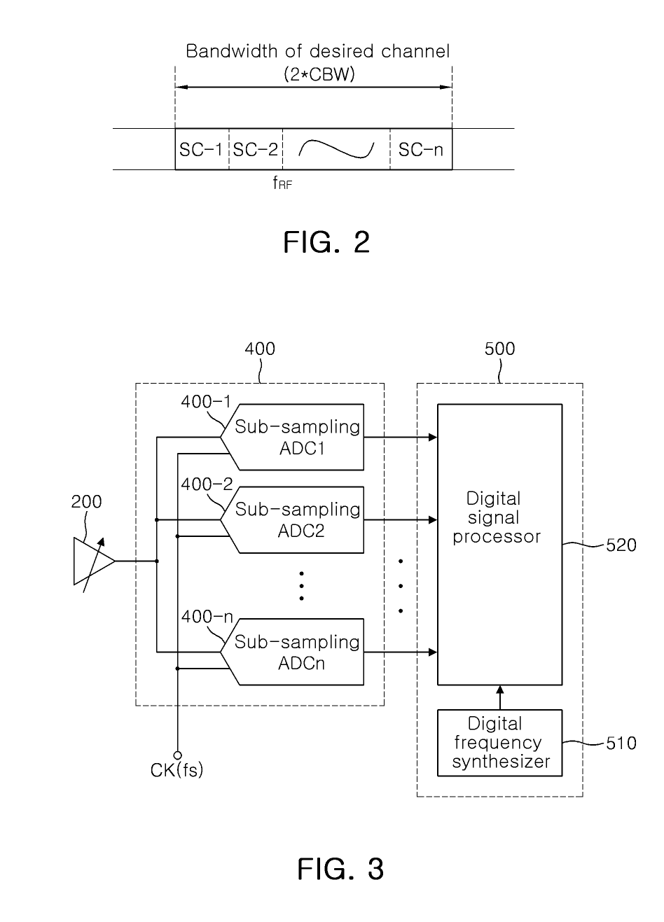

FIG. 2 illustrates the structure of sub-channels included in an RF signal to be processed according to an exemplary embodiment of the present invention. The RF signal, a process target of the present invention, includes a plurality of first, second to nth sub-channels SC-1, SC-2, . . . , SC-n within a band width (2*CBW) of a desired channel.

Meanwhile, the sub-sampling clock may be a single-sampling clock, or may be multiple sub-sampling clocks including a plurality of different first and second to nth sub-sampling clocks.

Examples of implementations of the sub-sampling A/D conversion unit 400 depending on whether the sub-sampling clock is a single sub-sampling clock or multiple sub-sampling clocks will now be described.

A first implementation of the sub-sampling A/D conversion unit 400 according to an exemplary embodiment of the present invention will now be described.

FIG. 3 is a schematic block diagram illustrating a first implementation example of the sub-sampling A/D conversion unit 400 according to an exemplary embodiment of the present invention. With reference to FIGS. 1 to 3, the clock generator 320 of the clock generation unit 300 generates the single sub-sampling clock CK from the reference frequency signal transferred from the crystal oscillator 310.

Then, each of the first, second to nth sub-sampling A/D converters 400-1, 400-2, . . . , 400-n of the sub-sampling A/D conversion unit 400 divides the RF signal transferred from the second filter unit 200 into a plurality of frequency bands according to the single sub-sampling clock CK transferred from the clock generation unit 300, and A/D-converts each of the RF signals of the divided frequency bands into a digital signal.

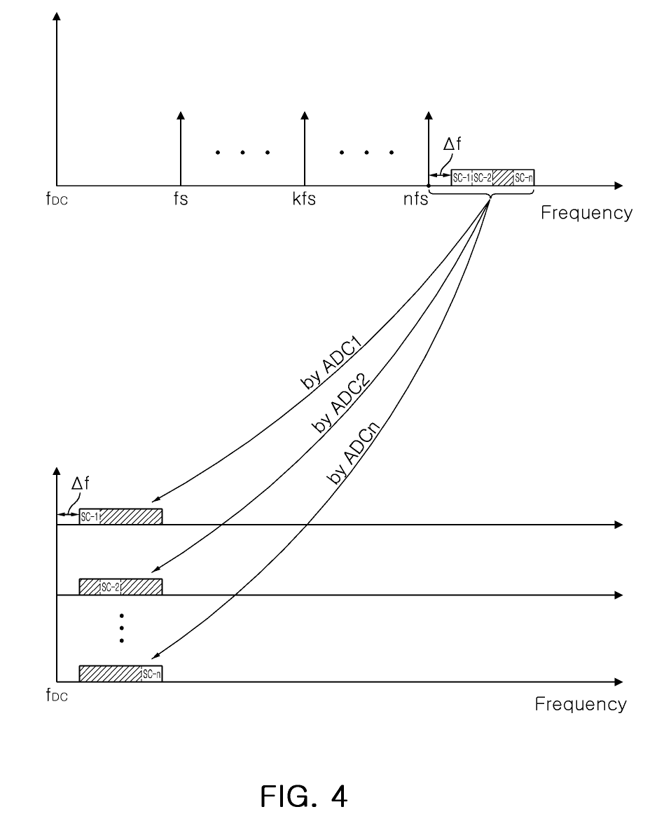

FIG. 4 is a pair of graphs for explaining the sub-sampling of the sub-sampling A/D conversion unit of FIG. 3.

With reference to FIGS. 1 to 4, each of the first, second to nth sub-sampling A/D converters 400-1, 400-2, . . . , 400-n sub-samples the RF signal from the second filter unit 200 according to the single sub-sampling clock CK.

In this case, as shown in FIG. 4, the information of each of the plurality of frequency bands is down-converted into the same frequency position by the integral multiple frequency (nF3, where “n” is a natural number) of the single sampling clock CK.

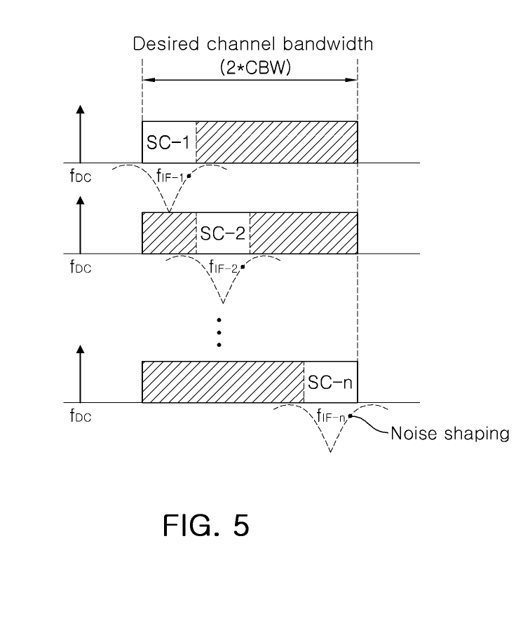

FIG. 5 illustrates noise-shaping the sub-sampling A/D conversion unit of FIG. 3.

With reference to FIGS. 1 to 5, a plurality of noise shaping frequencies of the plurality of first, second to nth sub-sampling A/D converters 400-1, 400-2, . . . , 400-n are set to have the same interval as the interval between the plurality of first, second to nth sub-channels included in the sub-sampled signal, and set to be the same as a center frequency of each of the plurality of first, second to nth sub-channels included in the sub-sampled signal.

Accordingly, noise-shaping is performed by the plurality of first, second to nth sub-channels.

In the first implementation of the sub-sampling A/D converter, the sub-sampling A/D conversion unit 400 may convert the RF signal from the second filter unit 200 into a pre-set IF signal, or may directly convert the RF signal from the second filter unit 200 into a DC-centered frequency band signal.

A second implementation of the sub-sampling A/D conversion unit 400 according to an exemplary embodiment of the present invention will now be described.

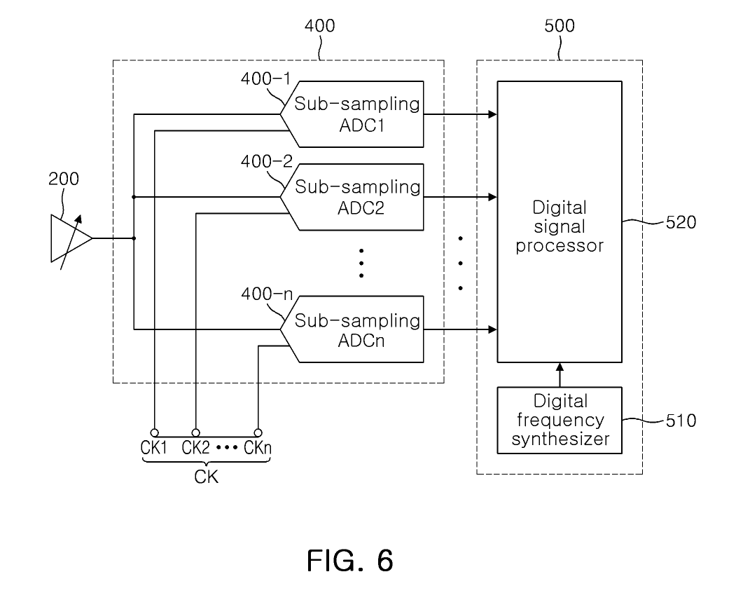

FIG. 6 is a schematic block diagram illustrating a second implementation example of a sub-sampling A/D conversion unit according to an exemplary embodiment of the present invention. With reference to FIGS. 1, 2, and 6, the clock generator 320 of the clock generation unit 300 generates multiple sub-sampling clocks including a plurality of different first, second to nth sub-sampling clocks CK1, CK2, . . . , CKn from the reference frequency signal from the crystal oscillator 310.

Then, as shown in FIG. 6, each of the first, second to nth sub-sampling A/D converters 400-1, 400-2, . . . , 400-n of the sub-sampling A/D conversion unit 400 divides the RF signal from the second filter unit 200 into a plurality of frequency bands and A/D-converts each of the RF signals of the divided frequency bands into a digital signal.

In the second implementation of the sub-sampling A/D conversion unit 400 according to an exemplary embodiment of the present invention, first and second sub-samplings can be divided depending on whether or not the frequency of the sub-sampling clock is the same as a center frequency of a sub-channel.

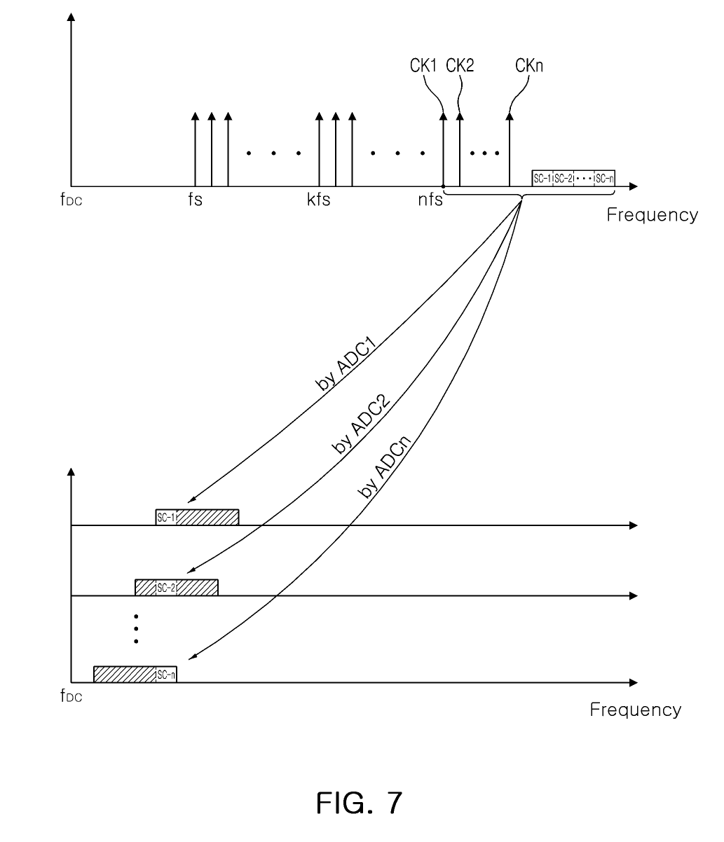

FIG. 7 is a pair of graphs for explaining the first sub-sampling of the sub-sampling A/D conversion unit of FIG. 6. With reference to FIGS. 1, 2, 6, and 7, each of the plurality of first, second to nth sub-sampling A/D converters 400-1, 400-2, . . . , 400-n may sub-sample the RF signal from the second filter unit 200 according to each of the first, second to nth sub-sampling clocks CK1, CK2, . . . , CKn from the clock generation unit 300 during the A/D conversion process.

Then, as shown in FIG. 7, the information of each of the plurality of frequency bands is down-converted into mutually different frequency positions by the integral multiple frequency (nFs, where “n” is a natural number) of the plurality of first, second to nth sub-sampling clocks CK1, CK2, . . . , CKn.

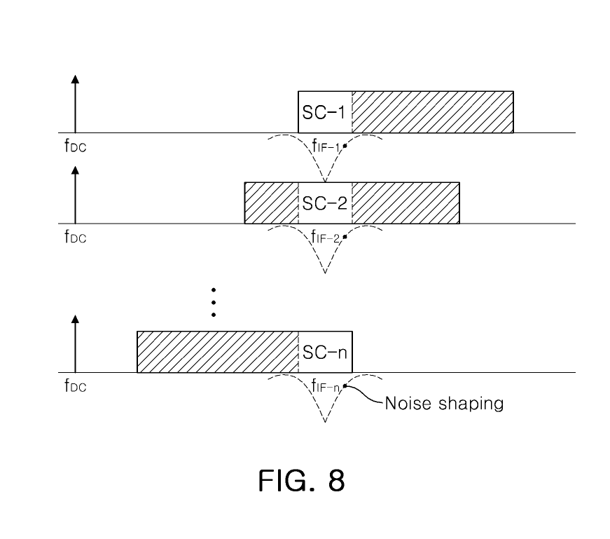

FIG. 8 illustrates the first noise-shaping of the sub-sampling A/D conversion unit 400 of FIG. 6.

With reference to FIGS. 1, 2, and 6 to 8, a plurality of noise shaping frequencies of the first, second to nth sub-sampling A/D converters 400-1, 400-2, . . . , 400-n are set to be the same as each other, and are also set to be the same as a center frequency of each of the plurality of first, second to nth sub-channels.

Accordingly, the noise-shaping is performed by the plurality of the first, second to nth sub-channels.

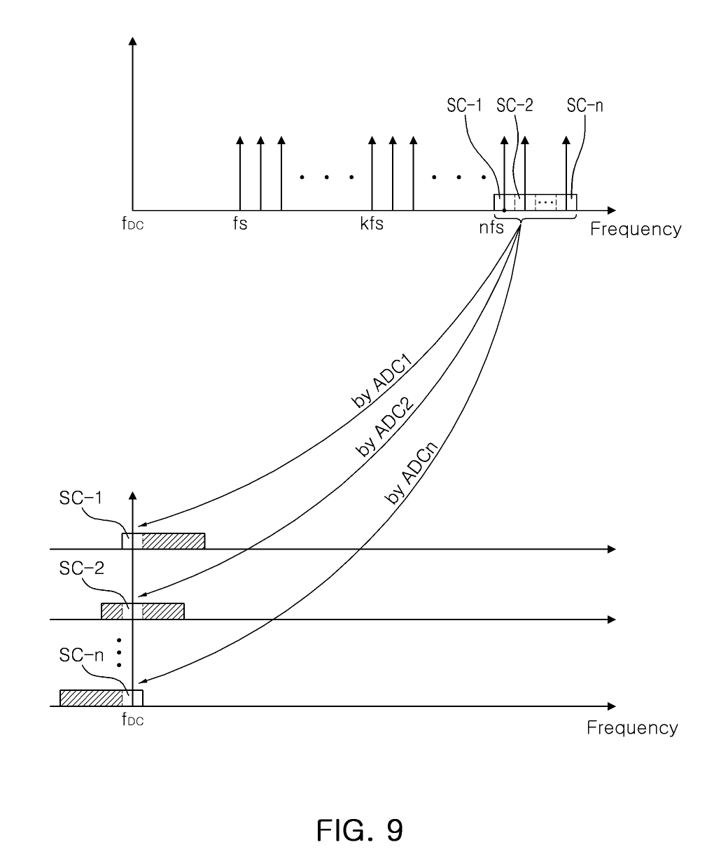

FIG. 9 is a pair of graphs for explaining second sub-sampling of the sub-sampling A/D conversion unit 400 of FIG. 6.

With reference to FIGS. 1, 2, 6, and 9, each of the plurality of first, second to nth sub-sampling A/D converters 400-1, 400-2, . . . , 400-n may sub-sample the RF signal from the second filter unit 200 according to each of the plurality of first, second to nth sub-sampling clocks CK1, CK2, . . . , CKn during the A/D conversion process.

Then, as shown in FIG. 9, the information of each of the plurality of frequency bands is down-converted into mutually different frequency positions by the integral multiple frequency (nFs, where “n” is a natural number) of the plurality of first, second to nth sub-sampling clocks CK1, CK2, . . . , CKn.

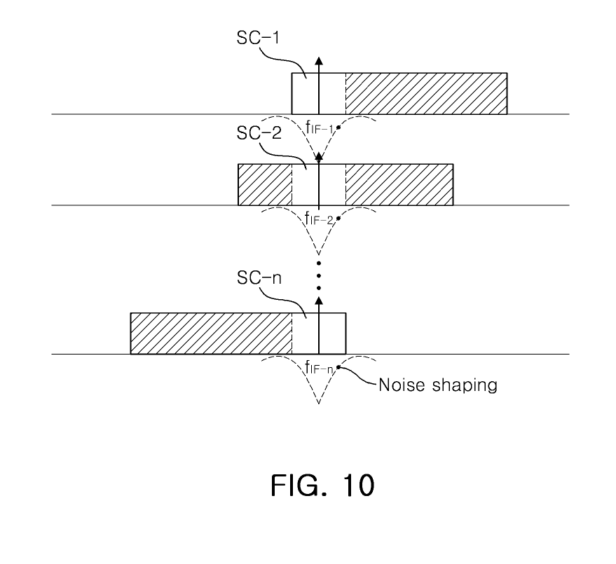

FIG. 10 illustrates second noise-shaping the sub-sampling A/D conversion unit 400 of FIG. 6.

With reference to FIGS. 1, 2, 6, 9, and 10, a plurality of noise shaping frequencies of the plurality of first, second to nth sub-sampling A/D converters 400-1, 400-2, . . . , 400-n are set to have the same interval as that between the plurality of first, second to nth sub-channels SC-1, SC-2, . . . , SC-n included in the sub-sampled signal, and in this case, the plurality of noise shaping frequencies are set to be the same as a center frequency of each of the plurality of first, second to nth sub-channels SC1-, SC2, . . . , SC-n included in the sub-sampled signal.

Each of the plurality of noise shaping frequencies of the first, second to nth sub-sampling A/D converters 400-1, 400-2, . . . , 400-n is set to be the same as the others, and is the same as the center frequency of each of the plurality of first, second to nth sub-channels.

Accordingly, the noise-shaping is performed by the plurality of first, second to nth sub-channels.

In the second implementation of the sub-sampling A/D conversion unit 400, the sub-sampling A/D converter 400 may convert the RF signal from the second filter unit 200 to an IF (Intermediate frequency) signal or to a DC-centered frequency band signal.

The sub-sampling A/D conversion unit 400 may include an I path sub-sampling A/D conversion unit and a Q path sub-sampling A/D conversion unit. In this case, the I-path sub-sampling A/D conversion unit and the Q-path sub-sampling A/D conversion unit may convert the RF signal into mutually orthogonal I and Q signals.

The operation and effect of the present invention will now be described with reference to the accompanying drawings.

The digital-intensive RF receiver according to an exemplary embodiment of the present invention will now be described with reference to FIGS. 1 to 10. First, as shown in FIG. 1, the digital-intensive RF receiver includes the first filter unit 50, the LNA 100, the second filter unit 200, the clock generation unit 300, the sub-sampling A/D conversion unit 400, and the digital processing unit 500.

The first filter unit 50 allows an RF signal of a pre-set frequency band, among a range of RF signals, to pass therethrough.

In detail, the first filter unit 50 may set the pre-set frequency band as a pass band. For example, a band in the range of 50 MHz to 900 MHz, corresponding to a TV frequency band, may be set as a pass band.

Accordingly, the first filter unit 50 may be an anti-aliasing filter allowing a passage of the pre-set frequency band, preventing data aliasing that may be possibly generated during the sub-sampling process.

The LNA 100 amplifies the RF signal from the first filter unit 50 to have a pre-set magnitude and outputs the same to the second filter unit 200. For example, if the LNA 100 is formed as a variable gain LNA, it may vary the gain according to the magnitude of the RF signal.

The second filter unit 200 allows the RF signal of the pre-set frequency band, among RF signal, from the LNA 100 to pass therethrough, so as to be output to the sub-sampling A/D conversion unit 400.

In detail, like the first filter unit 50 as described above, the second filter unit 200 may set the pre-set frequency band as a pass band. For example, a band in the range of 50 MHz to 900 MHz, corresponding to a TV frequency band, may be set as a pass band.

The clock generation unit 300 may generate a pre-set reference frequency signal, and generate a sub-sampling clock having a pre-set frequency lower than an RF carrier frequency by using the reference frequency signal.

For example, when the clock generation unit 300 includes the crystal oscillator 310 and the clock generator 320, the crystal oscillator 310 generates the reference frequency signal and provides it to the clock generator 320. The clock generator 320 generates the sub-sampling clock CK from the reference frequency signal transferred from the crystal oscillator 310 and provides the generated sub-sampling clock CK to the sub-sampling A/D conversion unit 400.

Here, the frequency of the sub-sampling clock may be determined as a frequency that can minimize data aliasing, and may be determined according to a desired RF signal bandwidth (2*CBW). For example, the sub-sampling frequency may be a frequency of substantially twice (2*20 MHz=40 MHz) the desired bandwidth (20 MHz), and in order to satisfy noise characteristics, the sub-sampling frequency may be a frequency more than twice the desired bandwidth.

Next, the sub-sampling A/D conversion unit 400 A/D-converts the RF signal transferred from the second filter unit 200, into a digital signal according to the sub-sampling clock from the clock generation unit 300. During the A/D conversion process, the sub-sampling A/D conversion unit 400 sub-samples the RF signal by dividing the RF signal into a plurality of frequency bands, and performs noise shaping by using the plurality of first, second to nth sub-channels included in the RF signal.

For example, the sub-sampling A/D conversion unit 400 may include the plurality of first, second to nth sub-sampling A/D converters 400-1, 400-2, . . . , 400-n, and in this case, the plurality of first, second to nth sub-sampling A/D converters 400-1, 400-2, . . . , 400-n may divide the RF signal, which has been transferred from the second filter unit 200, into a plurality of frequency bands according to the sub-sampling clock from the clock generation unit 300, and A/D-convert each of the RF signals of the divided frequency bands into a digital signal.

As described above, the sub-sampling A/D conversion unit 400 has the function of lowering the input signal band having a high frequency to the low IF or DC band and function of performing noise shaping on a signal of a certain desired narrow frequency band.

Accordingly, the use of the sub-sampling A/D conversion unit 400 allows for separating a broadband signal having a high signal frequency into a noise-shaped narrowband signal and processing it, which can be designed by using an ADC having a low operational frequency while maintaining a high bit resolution, thus obtaining a receiver performance with a current semiconductor fabrication technique.

Thus, in the exemplary embodiment of the present invention, the sub-sampling scheme for converting a high frequency signal into a low frequency signal and the noise shaping function of dividing a broadband signal into several sub-channels to process the broadband signal are combined.

Originally, although a broadband RF signal is sub-sampled, if the signal band itself is broad, it has a high sampling frequency. In this respect, however, in an exemplary embodiment of the present invention, noise shaping is performed on each of desired narrowband signals by using the bandpass A/D conversion, and the corresponding signals are processed again in a digital region, so the sub-sampling frequency can be significantly reduced.

Following the A/D conversion, the digital processing unit 500 processes the digital signal transferred from the sub-sampling A/D conversion unit 300 according to a system clock generated by using the reference frequency signal transferred from the clock generation unit 300.

Namely, the digital processing unit 500 can process a narrowband digital signal having a high signal-to-noise ratio. In addition, the sub-sampling A/D conversion unit 400 according to the present invention can support a high input dynamic range and process interferers in a digital region.

Thus, because the existing channel filter function can be moved to the digital stage, an RF frequency synthesizer for synthesizing channel frequencies is not required.

In more detail, for example, when the digital processing unit 500 includes the digital frequency synthesizer 510 and the digital signal processor 520, the digital frequency synthesizer 510 generates a system clock by using the reference frequency signal from the clock generation unit 300 and supplies the generated system clock to the digital signal processor 520.

The digital signal processor 520 processes a digital signal transferred from the sub-sampling A/D conversion unit 400 according to the system clock from the digital frequency synthesizer 510.

FIG. 2 illustrates the structure of sub-channels included in an RF signal to be processed according to an exemplary embodiment of the present invention. With reference to FIG. 2, the RF signal, the process target of the present invention, includes the plurality of first, second to nth sub-channels SC-1, SC-2, . . . , SC-n within the bandwidth (2*CBW) of the desired channel.

In FIG. 2, the BW indicates an overall received signal band, and the CBW refers to a channel bandwidth, a finally desired signal band.

The first implementation of the sub-sampling A/D conversion unit 400 will now be described with reference to FIGS. 1 to 3.

In FIG. 1, the clock generation unit 300 may include the crystal oscillator 310 and the clock generator 320. The crystal oscillator 310 of the clock generation unit 300 generates the reference frequency signal and provides the generated reference frequency signal to the clock generator 320. The clock generator 320 generates the signal sub-sampling clock CK from the reference frequency signal which has been transferred from the crystal oscillator 310.

In FIG. 3, the sub-sampling A/D conversion unit 400 may include the plurality of first, second to nth sub-sampling A/D converters 400-1, 400-2, . . . , 400-n. Each of the plurality of first, second to nth sub-sampling A/D converters 400-1, 400-2, . . . , 400-n may divide the RF signal from the second filter unit 200 into a plurality of frequency bands according to the signal sub-sampling clock CK from the clock generation unit 300, and A/D-convert each of the RF signals of the divided frequency bands into a digital signal.

With reference to FIGS. 1 to 4, each of the plurality of first, second to nth sub-sampling A/D converters 400-1, 400-2, . . . , 400-n sub-samples the RF signal from the second filter unit 200 according to the single sub-sampling clock CK from the clock generation unit 300.

In this case, as shown in FIG. 4, the information of each of the plurality of frequency bands is down-converted into the same frequency position by the integral multiple frequency (nF3) of the single sampling clock CK.

With reference to FIGS. 1 to 5, the plurality of noise shaping frequencies (f sub IF-1, f sub IF-2, . . . , f sub IF-n) of the plurality of first, second to nth sub-sampling A/D converters 400-1, 400-2, . . . , 400-n are set to have the same interval as that between the plurality of first, second to nth sub-channels SC-1, SC-2, . . . , SC-n included in the sub-sampled signal, and in this case, the plurality of noise shaping frequencies are set to be the same as the center frequency of each of the plurality of first, second to nth sub-channels SC1-, SC2, . . . , SC-n included in the sub-sampled signal.

In FIGS. 4 and 5, the overall signal band (BW) is converted into an IF by using a single clock, and frequency bands noise-shaped through each A/D conversion are arranged at sub-channel intervals.

Accordingly, noise-shaping is performed by the plurality of first, second to-nth sub-channels.

The second implementation of the sub-sampling A/D conversion unit 400 will now be described with reference to FIGS. 1, 2, and 6.

In FIG. 1, when the clock generation unit 300 includes the crystal oscillator 310 and the clock generator 320, the crystal oscillator the reference frequency signal and provides the generated reference frequency signal to the clock generator 320. The clock generator 320 generates a plurality of different first, second to nth sub-sampling clocks CK1, CK2, . . . , CKn from the reference frequency signal which has been transferred from the crystal oscillator 310.

With reference to FIG. 6, the sub-sampling A/D conversion unit 400 may include the plurality of first, second to nth sub-sampling A/D converters 400-1, 400-2, . . . , 400-n. The plurality of first, second to nth sub-sampling A/D converters 400-1, 400-2, . . . , 400-n may divide the RF signal from the second filter unit 200 into a plurality of frequency bands according to the plurality of first, second to nth sub-sampling clocks CK1, CK2, . . . , CKn from the clock generation unit 300, and A/D-convert each of the RF signals of the divided frequency bands into a digital signal.

In this manner, when the multiple clocks are used as shown in FIG. 6, the same A/D converter may be designed by differentiating only an operational frequency.

With reference to FIGS. 1, 2, 6, and 7, each of the plurality of first, second to nth sub-sampling A/D converters 400-1, 400-2, . . . , 400-n may sub-sample the RF signal from the second filter unit 200 according to each of the plurality of first, second to nth sub-sampling clocks CK1, CK2, . . . , CKn during the A/D conversion process.

Then, as shown in FIG. 7, the information of each of the plurality of frequency bands is down-converted into mutually different frequency positions by the integral multiple frequency (nFs) of the plurality of first, second to nth sub-sampling clocks CK1, CK2, . . . , CKn.

With reference to FIGS. 1, 2, and 6 to 8, each of the plurality of noise shaping frequencies of the first, second to nth sub-sampling A/D converters 400-1, 400-2, . . . , 400-n is set to be the same as each other, and is set to be the same as the center frequency of each of the plurality of first, second to nth sub-channels.

Accordingly, the noise-shaping is performed by the plurality of first, second to nth sub-channels.

With reference to FIG. 8, it is lowered to have the same IF of the sub-channels by using the multiple clocks having as long as the sub-channel interval. The desired signal channel band (CBW) of the sub-channels is divided into n number of bands and shown.

In this case, because the A/D conversion has the nose shaping function with respect to the narrowband sub-channels in the IF, a high bit resolution can be obtained at a desired sub-channel.

FIG. 9 is a pair of graphs for explaining the second sub-sampling of the sub-sampling A/D conversion unit of FIG. 6, and FIG. 10 illustrates the second noise-shaping of the sub-sampling A/D conversion unit of FIG. 6.

With reference to FIGS. 1, 2, 6, and 9, each of the first, second to nth sub-sampling A/D converters 400-1, 400-2, . . . , 400-n sub-samples the RF signal from the second filter unit 200 according to the plurality of first, second to nth sub-sampling clocks CK1, CK2, CKn.

With reference to FIGS. 1, 2, 6, 9, and 10, each of the plurality of noise shaping frequencies of the plurality of first, second to nth sub-sampling A/D converters 400-1, 400-2, . . . , 400-n are set to have the same interval as the interval between the plurality of first, second to nth sub-channels SC-1, SC-2, . . . , SC-n included in the sub-sampled signal, and set to be the same as the center frequency of each of the plurality of first, second to nth sub-channels SC-1, SC-2, . . . , SC-n included in the sub-sampled signal.

FIG. 9 shows the method of dropping all the desired signal frequency bands to DC by each A/D converter, which can be implemented by separating a signal into I and Q signals to thus perform complex signal conversion.

For a substantial example of the sub-sampling A/D conversion of FIGS. 7 and 9, a delta-sigma A/D conversion may be used. In this case, the delta-sigma A/D conversion may include a low pass type delta-sigma A/D conversion and a band pass type delta-sigma A/D conversion, a loop-filter function of the delta-sigma A/D conversion may be performed on an input signal and noise through, and a shaping function may be performed on quantization noise through feedback.

The signal with the improved signal-to-noise ratio at the desired band can be processed by the digital signal processor 520. The signal-to-noise ratio-improved signal band is a narrowband, so the narrowband signal can be processed, or respective narrowband signals can be combined to be processed.

In the first and second implementation examples of the sub-sampling A/D conversion unit 400 according to the exemplary embodiment of the present invention, the sub-sampling A/D conversion unit 400 can convert the RF signal from the second filter unit 200 into a pre-set IF signal, or directly convert the RF signal from the second filter unit 200 to a DC-centered frequency band signal.

As set forth above, in the digital-intensive RF receiver according to exemplary embodiments of the invention, when an RF signal is converted into an IF signal or a DC-centered frequency band signal through sub-sampling A/D conversion, noise shaping is performed by narrowbands of desired bands, thus removing the necessity of an RF tuner. Therefore, the RF receiver is advantageous for digital-specific design and can be designed to be smaller in size at a lower cost than the conventional analog-specific design.

While the present invention has been shown and described in connection with the exemplary embodiments, it will be apparent to those skilled in the art that modifications and variations can be made without departing from the spirit and scope of the invention as defined by the appended claims.

What is claimed is:

1. A digital-intensive RF receiver comprising:
a first filter unit configured to allow an RF signal of a pre-set frequency band among RF signals to pass therethrough;
a low noise amplifier (LNA) configured to amplify the RF signal from the first filter unit such that the RF signal has a pre-set magnitude;
a second filter unit configured to allow an RF signal of a pre-set frequency band among RF signals from the LNA to pass therethrough;
a clock generation unit configured to generate a pre-set reference frequency signal and generate a sub-sampling clock having a pre-set frequency lower than an RF carrier frequency by using the reference frequency signal;
a sub-sampling A/D conversion unit configured to A/D convert the RF signal from the second filter unit into a digital signal according to the sub-sampling clock from the clock generation unit, divide the RF signal into a plurality of frequency bands and sub-sample them during the A/D conversion process; and perform noise shaping on each of the sub-channels included in the RF signal; and
a digital processing unit configured to process a digital signal from the sub-sampling A/D conversion unit according to a system clock generated by using the reference frequency signal from the clock generation unit.

2. The RF receiver of claim 1, wherein the LNA is a variable gain LNA that varies a gain according to the magnitude of the RF signal.

3. The RF receiver of claim 1, wherein the clock generation unit comprises:
a crystal oscillator configured to generate the reference frequency signal; and
a clock generator configured to generate a sub-sampling clock from the reference frequency signal generated by the crystal oscillator.

4. The RF receiver of claim 3, wherein the sub-sampling clock is one or more of a single sub-sampling clock and multiple sub-sampling clocks including a plurality of different first, second to nth sub-sampling clocks.

5. The RF receiver of claim 4, wherein the sub-sampling A/D conversion unit comprises:
a plurality of first, second to nth sub-sampling A/D converters which divide the RF signal from the second filter unit into a plurality of frequency bands according to the single sub-sampling clock from the clock generation unit, and A/D-convert each of the RF signals of the divided frequency bands into a digital signal,
wherein each of the first, second, and nth sub-sampling A/D converters may sub-sample the RF signals from the second filter unit according to the sub-sampling clock from the clock generation unit.

6. The RF receiver of claim 5, wherein each of the plurality of noise shaped frequencies of the plurality of the first, second, and nth sub-sampling A/D converters is set to have the same interval as that between the plurality of first, second, and nth sub-channels included in the sub-sampled signals, and set to have the same frequency as a center frequency of each of the plurality of the first, second, and nth sub-channels included in the sub-sampled signals.

7. The RF receiver of claim 5, wherein each of the plurality of noise shaped frequencies of the plurality of the first, second, and nth sub-sampling A/D converters is set to have the same frequency as each other, and is set to have the same frequency as a center frequency of each of the plurality of the first, second, and nth sub-channels included in the sub-sampled signals.

8. The RF receiver of claim 1, wherein the digital processing unit comprises:
a digital frequency synthesizer configured to generate a system clock by using the reference frequency signal from the clock generation unit; and
a digital signal processor configured to process a digital signal from the sub-sampling A/D conversion unit.

9. The RF receiver of claim 1, wherein the sub-sampling A/D conversion unit converts the RF signal from the second filter unit into second filter unit into one of a pre-set IF signal and DC-centered frequency band signal.

10. The RF receiver of claim 1, wherein the sub-sampling A/D conversion unit comprises an I-path sub-sampling A/D conversion unit and a Q-path sub-sampling A/D conversion unit, and converts the RF signals into I and Q signals which are in an orthogonal relationship by using pre-set orthogonal first and second clock signals.
